(19) United States
(12) Patent Application Publication
(10) Pub. No.: US 2023/0288227 A1
(43) Pub. Date: Sep. 14, 2023

(54) SENSOR CLUSTER MODULE

(71) Applicant: Martin Burmeister, Stockton, CA (US)

(72) Inventor: Martin Burmeister, Stockton, CA (US)

(21) Appl. No.: 18/182,028

(22) Filed: Mar. 10, 2023

Related U.S. Application Data
(60) Provisional application No. 63/318,631, filed on Mar. 10, 2022.

(51) Int. Cl. G01C 25/00; H01R 13/193; G01C 21/16

(52) U.S. Cl. CPC G01C 25/00; H01R 13/193; G01C 21/166; H01R 2201/20; H01R 2201/26

(57) ABSTRACT

An IMU may comprise a frame made of cast aluminum or injection molded plastic and a flexible PCBA wrapped at least partially around the frame. The PCBA may house electronic components include one or more of: a Y-axis component, an X-axis component, a Z-axis component and an application specific integrated circuit (ASIC) which are each located on a different side of the frame. A flexible tail having a connector may be used as an interface to the IMU. The connector may be designed to mate with a zero insertion force (ZIF) socket. Such IMU may be employed for automobile applications.

### CROSS REFERENCE TO RELATED APPLICATIONS

This application claims the benefit of U.S. Provisional Application Ser. No. 63/318,631, filed on Mar. 10, 2022, the contents of which are incorporated by reference herein.

### BACKGROUND

Autonomous driving applications require highly accurate positioning and navigation systems. Such navigation systems employ inertial measurement units (IMUs) for measuring rotation, acceleration and orientation among other forces, along three independent axes. Modern automobiles, especially autonomous automobiles, require real-time, constant and accurate position and motion estimation abilities throughout any environmental changes. Vehicles of all types, including cars, trucks, buses, drones, robotics, human powered vehicles and the like must be able to determine where they are and where they are going in various weather, temperature and landscape environments, as well as in situations where a global positioning signal (GPS) is unavailable.

Automotive electronics may account for as much as forty-five percent of the cost of a new car or truck and likely to continue to become even more expensive. Thus, there is a need to produce highly accurate IMUs for automobile applications at a low price point. Conventional IMU devices fail to employ standard printed circuit board (PCB) technology and therefore suffer from drawbacks including manufacturing difficulty and high cost.

FIG. 1 is an illustration of a conventional three-dimensional (3D) foldable IMU device of U.S. Pat. No. 8,368,154 to Trusov et al. The Trusov device employs flexible hinges for folding individual semiconductor-device substrates, each having sensor units mounted thereon, into place. Latches are used to connect the semiconductor-device substrates and hold the 3D structure together. Such hinges and latches make the IMU of Trusov difficult and costly to manufacture.

Other conventional 3D type IMU devices suffer from similar drawbacks. FIG. 2 shows a multi sensor unit folded in a pyramid shape by Zotov et al. in a paper titled “Folded MEMS Pyramid Inertial Measurement Unit.” Each sidewall of the pyramid comprises a sensor, e.g. an accelerometer or gyroscope. Signals from the sensors are sent, via flexible electrical interconnects, to a base of the IMU which forms a base of the pyramid. To form the sides, sidewalls are folded around a plastic pyramid shape form. Like the IMU disclosed by Trusov, Zotov relies on costly mechanical latches and hinges.

Accordingly, a more cost effective IMU would be beneficial for automotive applications.

### SUMMARY

An inertial measurement unit (IMU) may comprise a frame made of cast aluminum or injection molded plastic and a flexible printed circuit board assembly (PCBA) wrapped at least partially around the frame. The PCBA may house electronic components include one or more of: a Y-axis component, an X-axis component, a Z-axis component and an application specific integrated circuit (ASIC) which are each located on a different side of the frame. A flexible tail having a connector may be used as an interface to the IMU. The connector may be designed to mate with a zero insertion force (ZIF) socket. Such IMU may be employed for automobile applications.

### BRIEF DESCRIPTION OF THE DRAWINGS

FIG. 1 is an illustration of a conventional three-dimensional (3D) foldable inertial measurement unit (IMU) device;

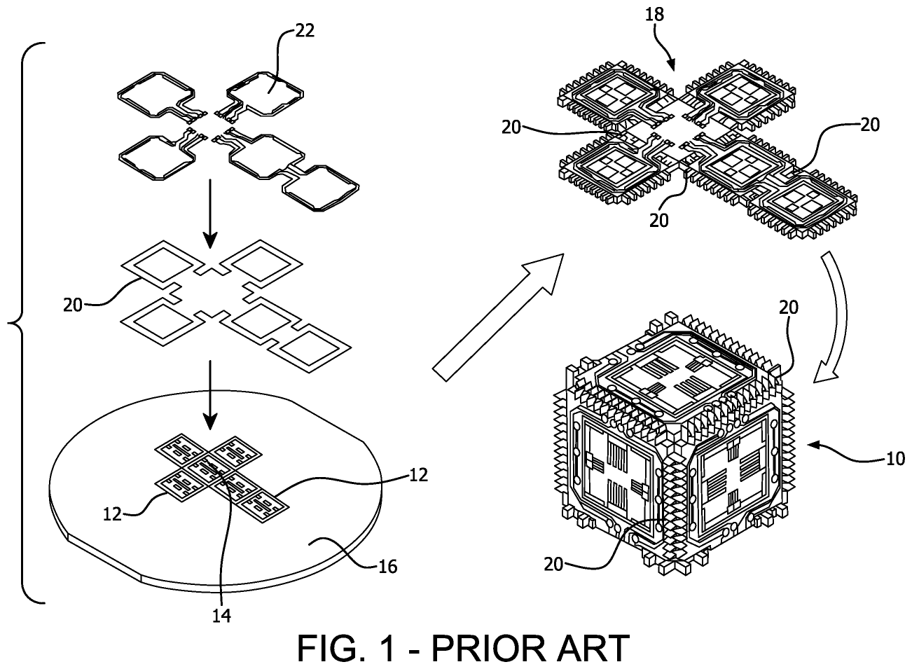

FIG. 2 is an illustration of a conventional multi sensor unit folded in a pyramid shape;

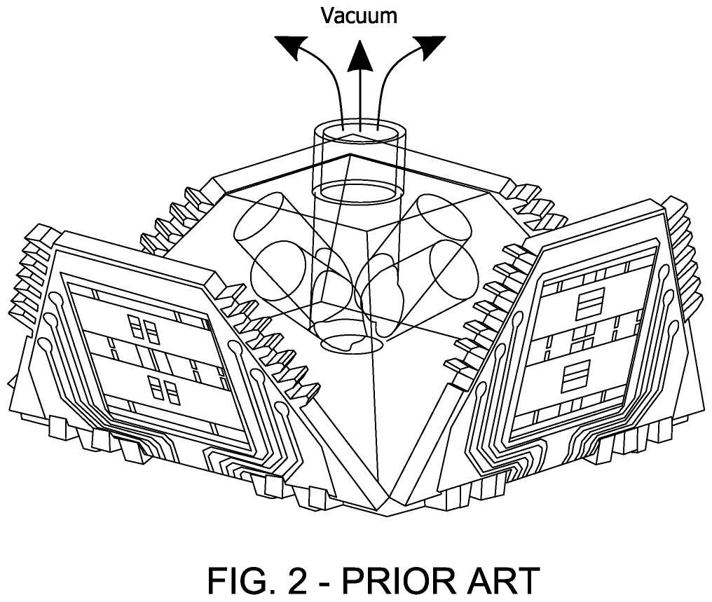

FIG. 3 is an illustration of an example sensor cluster module in accordance with an embodiment;

FIG. 4 is a flowchart of an example method of manufacturing the sensor cluster module of FIG. 3.; and

FIG. 5 is an illustration of example frame designs.

### DETAILED DESCRIPTION

As mentioned above, autonomous driving applications require highly accurate positioning and navigation systems. Such navigation systems employ inertial measurement units (IMUs) for measuring rotation, acceleration and orientation among other forces, along three independent axes.

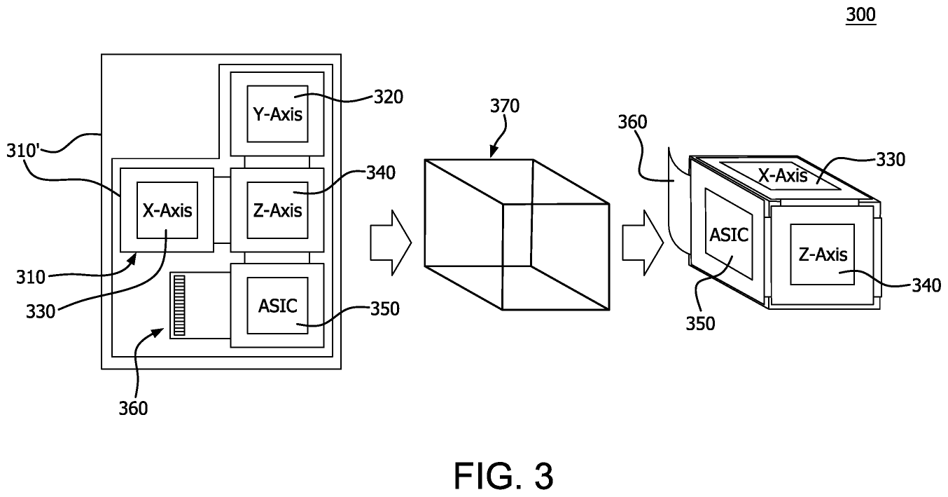

FIG. 3 is an illustration of a sensor cluster module 300. The left hand side of FIG. 3 illustrates a circuit board 310 which could be a rigid flex board or non-rigid circuit board. In an embodiment, the circuit board is a rigid flex board 310′ incorporating standard printed circuit board (PCB) sections coupled together via flexible circuits. A rigid portion of the circuit board may be made of laminate poly with traces. A flexible circuit board may be made of a polyimide material which is flexible and thinner than a rigid circuit board since it may not have mechanical reinforcement. Both flexible and rigid PCBs may have one or more, e.g. multiple layers of circuit traces.

Manufacturing and assembly of the circuit board may be performed, for example, using standard surface mount technology with solder alloys, or the like.

Where a circuit is made of flexible PCB, the entire PCB may be made of flexible polyimide. To give the device structure, a rigid material may be laminated to the flexible polyimide. For example, epoxy glass, metal or ceramic may be laminated to the back or front of the flexible polyimide sections.

A sensor cluster module includes a circuit board frame, and a printed circuit board assembly (PCBA) disposed at least partially around the frame.

The sensor cluster module may be an inertial measurement module (IMU).

The sensor cluster module includes the PCBA is rigid-flex printed board assembly.

The sensor cluster module includes the PCBA includes a plurality of rigid elements, each rigid element comprising an electronic component.

The sensor cluster module includes the electronic components include one or more of: a Y-axis component, an X-axis component, a Z-axis component and an application specific integrated circuit (ASIC).

The sensor cluster module includes the PCBA comprises a flexible tail having a connector.

The sensor cluster module includes one or more of the electronic components are located on an inside surface of the circuit board frame.

The sensor cluster module includes one or more of the electronic components are located on an outside surface of the circuit board frame.

The sensor cluster module includes the circuit board frame includes guide elements for wrapping the PCBA to the frame.

The sensor cluster module includes the PCBA is glued to the circuit board frame.

The sensor cluster module includes the PCBA is glued to the frame using ultraviolet (UV) cure epoxy adhesive.

The sensor cluster module includes the frame is in the shape of a pyramid.

The sensor cluster module includes the frame is in the shape of a cube.

The sensor cluster module includes the frame is octagonal in shape.

The sensor cluster module includes the circuit board frame is a made of cast aluminum.

The sensor cluster module includes the circuit board frame is a made of injection molded plastic.

The sensor cluster module includes the frame is hollow.

A method for manufacturing an inertial measurement unit (IMU) includes attaching electronics to a printed circuit board, wherein the electronics comprise three dimensional sensors. The printed circuit board is routed out from a circuit board frame. The circuit board frame is formed in a desired shape. The printed circuit board is folded and mounted around the circuit board frame. The circuit board frame is encapsulated in a package. The package is mounted to a second circuit board.

The method further comprises providing a flexible connector for connection to a zero insertion force (ZIF) socket.

The method includes forming the circuit board in a desired shape that includes forming the circuit board into any one of the following shapes: a cube, a pyramid, a hexagon or an octagon shape.

For example, in FIG. 3, each of the square elements supporting the Y-axis section 320, X-axis section 330, Z-axis section 340 and application specific integrated circuit (ASIC) devices 350 could be supported by rigid backer elements to add mechanical structure. A flex connector 360 may be employed to mate with a zero-insertion force (ZIF) receptacle (not shown).

In an embodiment, electronic components may be placed on one side of the PCB. In another embodiment, electronic components may be placed on more than one side of the PCB. It may be beneficial to mount electronic components to an inner side of the PCB such that the component is located within a frame of the sensor cluster module. Electrical testing of the PCB and electronic components may be performed in advance of mounting the PCB to a frame 370 and/or once the PCB is mounted.

Such frame 370 may be manufactured before or after manufacture of a PCB. The frame 370 may be made of cast aluminum or may be made via injection molding among other methods such that the frame 370 will not melt in high temperature applications. Example plastics for use by the frame 370 may include ULTEM or polyetheretherketone (PEEK). ULTEM is an amorphous polyetherimide with good thermal performance and high mechanical strength and stiffness. PEEK is a high-performance plastic with excellent mechanical strength and dimensional stability. Such materials are suitable for maintaining stiffness at high temperatures.

The frame 370 may be shaped into a cubic frame (or other shape frame not shown) and may be created before or after completion of the PCB. Such frame 370 may be created from injection molded plastic, via cast aluminum or via other materials. The frame 370 may be made rigid and may or may not be hollow or partially hollow inside such that additional electronics may be incorporated inside the frame in an area central to the primary motion electronics. The frame 370 may have guides, e.g. guide pins, grooves or ridges, to make it easier to wrap the circuit board around the frame during fabrication. The circuit board 310 may be glued, using epoxy, to the frame 370. In embodiments, glue may be applied to flexible sections of the circuit board 310 before mounting the circuit board 310 to the frame 370. Alternatively, or in combination, glue may be applied to the frame 370 itself.

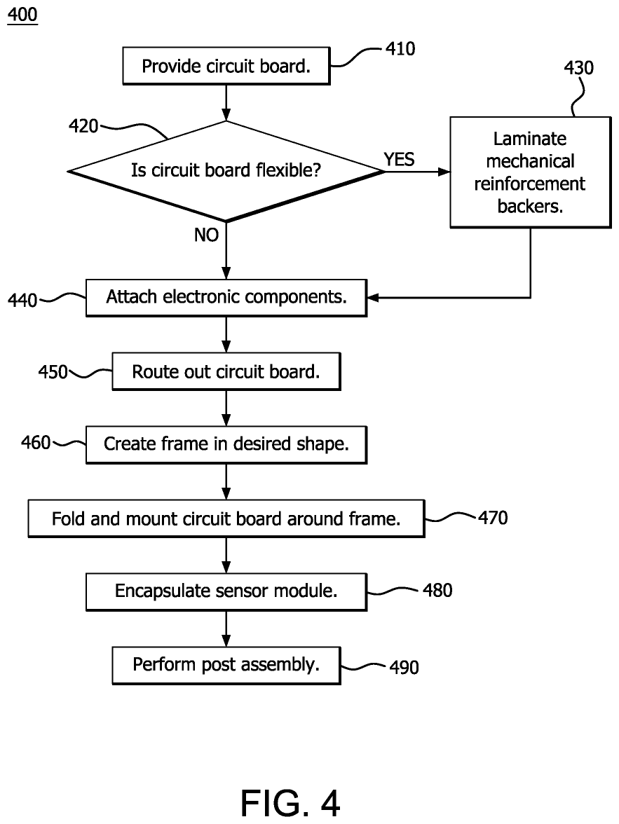

FIG. 4 is a flowchart of an example method 400 of manufacturing the sensor cluster module 300 of FIG. 3. The manufacturing process may begin by providing a circuit board that is flexible or rigid-flex (step 410). There may be a need to laminate mechanical reinforcement backers for flexible portions to add rigidity to side portions of the IMU such that electronics may be attached and to ensure the accuracy of the IMU.

Accordingly, if the circuit board is a flexible circuit board (step 420), then mechanical reinforcement backers are laminated onto it (step 430). Step 430 may be performed in advance, such as by a supplier prior to providing the circuit board in step 410.

In step 440, electronic components are attached to the circuit board. That is, for example, electronics, such as single axis sensors may be attached to the circuit board such that each axis device will be orthogonal to one another once the circuit board is mounted to the frame. Example electronics include, but are not limited to: accelerometers, gyroscopes and magnetometers. In embodiments, the circuit board may support 3-axis devices, 6-axis devices or 9-axis devices among other possibilities.

Once the electronics may be attached to the circuit board, the circuit board may be routed out from a circuit board frame such that the circuit board may be manipulated in 3 dimensions (step 450). An example of this routing can be seen in FIG. 3. The frame may be formed in a desired shape (step 460), which is discussed further below, by folding and mounting the circuit board to the frame (step 470).

In an example, custom automation and mass production may be employed in the wrapping process. Manual wrapping may be performed in devices as well (e.g., prototype devices).

The sensor module may be encapsulated in step 480, for example, with a lid made of glass or other material. An adhesive may be employed to glue the lid to a substrate. The sensor cube may be encased in a plastic or metal housing comprising 2 pieces (box and lid) for example. A rigid enclosure may protect the assembly from the elements and during handling and assembly. There numerous ways form an enclosure.

Once completed, the IMU may be attached to a circuit board via a flex connector and a ZIF socket of the circuit board as part of post assembly (step 490). Such a ZIF socket may employ a clamp mechanism that clamps the flex connector to the ZIF socket. The flex connector provides an interface to electronic components outside of the IMU package.

In embodiments, an IMU may be mounted to a circuit board via other mechanisms other than a ZIF socket. For example, the IMU may be soldered on. For example, a connector component may be soldered onto the sensor cube.

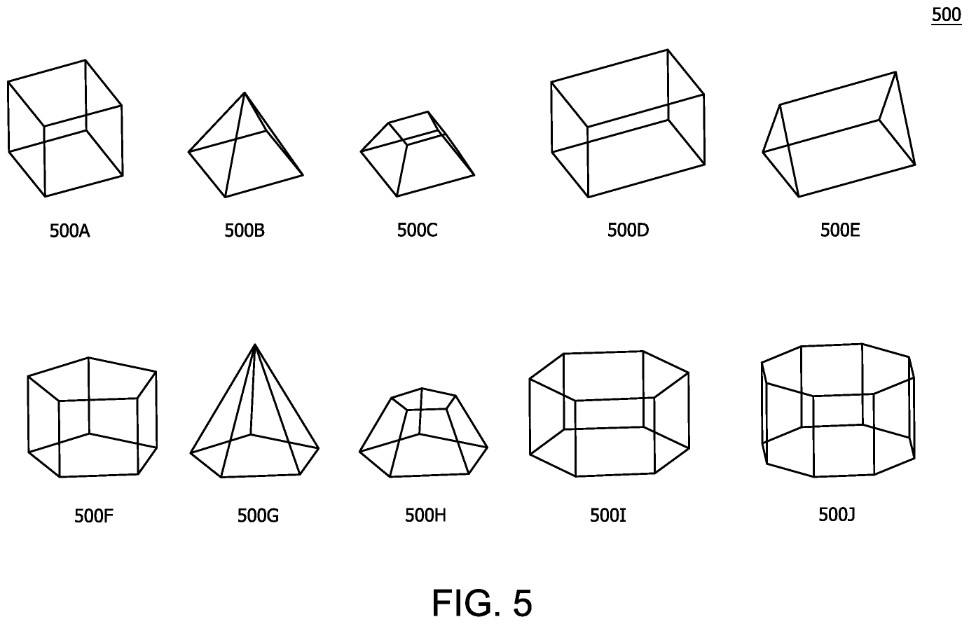

FIG. 5 shows frame shape design choices 500. For example, based on a number of electronic devices to be included in an IMU, a designer may choose one of the shapes disclosed in FIG. 5. A number of sides may be selected to support a number of orthogonal axis devices plus a base side and a side to house an application specific integrated circuit (ASIC). For prototyping or manufacturing, an existing aluminum or plastic body may be routed out to form a shape design.

In examples, shapes may be selected to have 6, 7, 8, 9, 10, 11, 12 or more sides. Frame designs may incorporate a flat base and pointed top, such as a pyramid shape. Frame designs may incorporate a smaller base side as compared to an overall length of the frame. Frame designs may be cubic or rectangular. Frames may be octagonal or hexagonal in design.

For example, frame 500A is a cube shape. Frame 5008 is a pyramid shape. Frame 500C is a trapezoid shape. Frame 500D is a rectangle shape. Frame 500E is a wedge shape. Frame 500F is a pentagon shape. Frame 500G is a pyramid shape with a pentagon base.

Frame 500H is a frame having a pentagon base and top. Frame 500I is a frame having a hexagon base and top. Frame 500J has an octagon base and top. However, it should be noted that an frame shape may be utilized as a frame shape shown in FIG. 5.

In examples, IMU devices may be configured to work with global navigation satellite system (GNSS) sensors such information derived from an IMU and a GNSS may be fused. Information from either device may be useful in assisting an automobile in crash detection, occupant detection/position, speed, acceleration, positioning, rotation, elevation and the like.

In embodiments, a Field Programmable Gate Array (FPGA), Digital Signal Processor (DSP) or General Purpose Processor (GPP) may be substituted for an ASIC. Such device may communicate information from the IMU to a cellular transceiver (included in the automobile or a connected cellular telephone) or other transceiver via an automobile communication system. Information of the IMU may be communicated among automobiles or to other devices via vehicle to vehicle (V2X) communication standards.

What is claimed is:

1. A sensor cluster module comprising:
a circuit board frame; and
a printed circuit board assembly (PCBA) disposed at least partially around the frame.

2. The sensor cluster module of claim 1, wherein the sensor cluster module is an inertial measurement module (IMU).

3. The sensor cluster module of claim 1, wherein the PCBA is rigid-flex printed board assembly.

4. The sensor cluster module of claim 3, wherein the PCBA includes a plurality of rigid elements, each rigid element comprising an electronic component.

5. The sensor cluster module of claim 4, wherein the electronic components include one or more of: a Y-axis component, an X-axis component, a Z-axis component and an application specific integrated circuit (ASIC).

6. The sensor cluster module of claim 5, wherein the PCBA comprises a flexible tail having a connector.

7. The sensor cluster module of claim 6, wherein one or more of the electronic components are located on an inside surface of the circuit board frame.

8. The sensor cluster module of claim 6, wherein one or more of the electronic components are located on an outside surface of the circuit board frame.

9. The sensor cluster module of claim 1, wherein the circuit board frame includes guide elements for wrapping the PCBA to the frame.

10. The sensor cluster module of claim 1, wherein the PCBA is glued to the circuit board frame.

11. The sensor cluster module of claim 10, wherein the PCBA is glued to the frame using ultraviolet (UV) cure epoxy adhesive.

12. The sensor cluster module of claim 1, wherein the frame is in the shape of a pyramid.

13. The sensor cluster module of claim 1, wherein the frame is in the shape of a cube.

14. The sensor cluster module of claim 1, wherein the frame is octagonal in shape.

15. The sensor cluster module of claim 1, wherein the circuit board frame is a made of cast aluminum.

16. The sensor cluster module of claim 1, wherein the circuit board frame is a made of injection molded plastic.

17. The sensor cluster module of claim 1, wherein the frame is hollow.

18. A method for manufacturing an inertial measurement unit (IMU), the method comprising:
attaching electronics to a printed circuit board, wherein the electronics comprise three dimensional sensors;
routing out the printed circuit board from a circuit board frame;
forming the circuit board frame in a desired shape;
folding and mounting the circuit board around the circuit board frame;
encapsulating the frame in a package; and
mounting the package to a second circuit board.

19. The method of claim 18, further comprising providing a flexible connector for connection to a zero insertion force (ZIF) socket.

20. The method of claim 18 wherein forming the circuit board in a desired shape includes forming the circuit board into any one of the following shapes: a cube, a pyramid, a hexagon or an octagon shape.
